(19) United States
(12) Patent Application Publication
(10) Pub. No.: US 2007/0201229 A1
(43) Pub. Date: Aug. 30, 2007

(54) Light source apparatus

(75) Inventors: Koji Yamada, Hygo (JP); Tetsuji Hirao, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA

(21) Appl. No.: 11/710,425

(22) Filed: Feb. 26, 2007

(30) Foreign Application Priority Data
Feb. 27, 2006 (JP) 2006-049975

(51) Int. Cl. F21S 8/00

(52) U.S. Cl. 362/263

(57) ABSTRACT

A light source apparatus comprises a mercury lamp having an arc tube having a light emitting portion and sealing portions extending from both sides of the light emitting portion, respectively and, a concave reflection mirror which reflects light emitting from the discharge lamp in a predetermined direction, and a front glass made from light transmissive material, which is arranged in an opening side of the concave reflection mirror, wherein a reflective surface of the concave reflection mirror is made of metal, and, wherein a reflective film which reflects infrared light and ultraviolet light, is formed on a surface of the front glass, and the infrared light and ultraviolet light which emitted from the extra-high mercury discharge lamp are reflected on the front glass so as to be returned to part of electrodes of the extra-high pressure mercury lamp or between the electrodes.

### CROSS-REFERENCES TO RELATED APPLICATION

This application claims priority from Japanese Patent Application Serial No. 2006-49975 filed on Feb. 27, 2006, the contents of which are incorporated herein by reference in its entirety.

### TECHNICAL FIELD

Described herein is a light source apparatus, and specifically, an optical apparatus used for an optical system of a projector apparatus using a liquid crystal device, a DMD device, etc.

### BACKGROUND

In recent years, a projector apparatus is used in various scenes, such as a meeting or school (education), and even individuals purchase and use it for a home theater. Thus, use of such a projector is being expanded. Since especially the forms of meetings have been diversified, it is becoming common that such a projector apparatus is used not only at a meeting held by a number of people but also at a meeting held by a couple of people. Under the circumstances, it is more convenient to carry the projector apparatus in a conference room or a classroom, than to install it therein, and therefore the miniaturization of the projector apparatus is expected. Moreover, it is demanded that an inexpensive projector apparatus be manufactured, so that individuals can purchase such a projector.

In order to make such a projector apparatus inexpensive while miniaturizing it, it is desirable that a lighting ballast for a light source apparatus installed in the projector apparatus be miniaturized. The weight and cost of the projector apparatus is large in an occupation rate. In order to miniaturize the lighting ballast, it is important to suppress generation of heat of parts thereof by lowering current at time of lighting of the extra-high pressure mercury lamp which forms a light source apparatus, and in order to lower the current value at the time of lamp lighting, it is necessary to carry out the lighting with low electric power.

Since when electric power for lighting is just lowered, it is difficult to raise the temperature of the tip of an electrode section to a predetermined high temperature at time of lighting, the thermionic emission from the electrode tip section becomes insufficient so that the light emission from the extra-high pressure mercury lamp becomes momentarily unstable and the so-called flicker phenomenon occurs, that is, an image projected by the projector apparatus flickers. Moreover, in such a case, since a light output emitted from the extra-high pressure mercury lamp decreases, a predetermined output required for the projector apparatus cannot be secured. Under such circumstances, such a method of lowering the lighting electric power of the extra-high pressure mercury lamp cannot be simply used.

FIGS. 5A, 5B, and 5C show cross sectional views of conventional light source apparatuses, respectively, each of which is taken along a plan including its optical axis.

In FIGS. 5A, 5B and 5C, “UV” represents ultraviolet, “VIS” represents visible light, and “IR” represents infrared light. As shown in FIG. 6, in general, a light source apparatus comprises a concave glass reflection mirror 1′, on which a reflective film 14′ made from a dielectric multilayer film for reflecting the VIS to a reflective surface 12′ is formed, a front glass 2′ which is inserted in an end opening portion 11′ of the concave reflection mirror 1′, and an extra-high pressure mercury lamp 3′. And this concave glass reflection mirror 1′ has a function of transmission of UV and IR to a back side of the concave reflection mirror 1′, among the UV, VIS, and IR which are emitted from an electric discharge arc (luminescent spot) P′ formed between electrodes 34′ and 35′ of the extra-high pressure mercury lamp 3, and a function of reflecting only the VIS in the direction of the light emitting direction. Therefore, the concave reflection mirror 1′ is provided so as to surround the light source apparatus. For example, since circumference components (not shown) such as a light source housing made of synthetic resin or an insulated film (such as silicon type resin, fluorine type resin) of a power feeder 4′ fixed to the reflection mirror is exposed to the U and IR which transmits through the concave reflection mirror 1′, there is a possibility that the light source housing deteriorates whereby it becomes weak or the insulated film of the power feeder 4′ melts. Refer to Japanese Laid Open patent Nos. H08-7841, 2005-347202, and 2005-292421.

### SUMMARY

In the present light source apparatus, it is possible to solve the above problem of degradation of the circumference components provided in the light source apparatus, while it is possible to make the projector apparatus small and inexpensive by reducing electric power for lighting the high pressure lamp. In the lamp, 0.15 mg/mm³ or more mercury may be enclosed in the arc tube.

The light source apparatus may comprise an extra-high pressure mercury lamp having an arc tube having a light emitting portion and sealing portions extending from both sides of the light emitting portion, in which a pair of electrodes facing each other is provided and, mercury of 0.15 mg/mm³ or more is enclosed, a concave reflection mirror which reflects light emitting from the discharge lamp in a predetermined direction and which surrounds the extra-high pressure mercury lamp, and a front glass made from light transmissive material, which is arranged in an opening side of the concave reflection mirror, in which (1) a reflective surface of the concave reflection mirror is made of metal, and, (2) a reflective film which reflects infrared light and ultraviolet light, is formed on a surface of the front glass, and the infrared light and ultraviolet light which emitted from the extra-high mercury discharge lamp are reflected on the front glass so as to be returned to part of electrodes of the extra-high pressure mercury lamp or between the electrodes.

(1) Since the reflective surface of the concave reflection mirror is made of metal, light in the entire wavelength band which is emitted from the extra-high pressure mercury lamp is reflected by the reflection mirror, and does not transmit toward the back side of the reflection mirror. Therefore, a light source housing etc. which is arranged so as to enclose the light source apparatus may not be exposed to ultraviolet light and infrared light, so that the light source house etc. may not deteriorate.

(2) The ultraviolet light and infrared light emitted from the discharge arc is reflected by the reflective film which is formed on the concave reflection mirror and the front glass, and is emitted on part of the electrode and the discharge arc. Therefore, since it is possible to change the temperature of the tip portions of the electrodes at time of lighting, into a predetermined high temperature even if the electric power for lighting the extra-high pressure mercury lamp is low, it is possible to suppress the flicker phenomenon due to a decrease of the temperature of the electrodes, and since the mercury steam which exists between electrodes in the electrical discharge space is excited so that the brightness of the discharge arc formed between the electrodes also becomes high. Therefore, even if electric power for lighting the extra-high pressure mercury lamp is decreased, an optical output required for the light source of the projector apparatus can be secured.

Further, the reflective film may be provided on the extra-high pressure mercury lamp side of the front glass so that it has technical advantages as set forth below.

As shown in FIG. 2A, when the reflective film is provided in the light emitting side (the opposite side of the extra-high pressure mercury lamp) of the front glass, that is, on the left side in the figure, the ultraviolet radiation and infrared light which are emitted from the extra-high pressure mercury lamp transmits through the front glass twice in total. For example, when the front glass made from quartz glass, whenever it transmits through the front glass once, the intensity of ultraviolet radiation and infrared light will drops by 4% thereof in general. By doing so, when the ultraviolet radiation and infrared light transmit through the front glass twice, the intensity of ultraviolet radiation and infrared light will drops by 16% in general. Since in the structure of the present light source apparatus, the ultraviolet radiation and infrared light which are emitted from the extra-high pressure mercury lamp, as shown in FIG. 2B, do not transmit through the front glass, so that the light intensity thereof does not decrease.

The above-mentioned concave reflection mirror may have the spheroidal shape in which part of an ellipse is included in a cross sectional view thereof, taken along a plane including the optical axis thereof. The front glass may have a concave section and a plane section, in which the above-mentioned the front glass is provided so as to have a concave shape as a whole, and the concave section is located in the extra-high-pressure-mercury-lamp side and the plane section is located in the outside of the concave reflection mirror so that it has technical advantages as set forth below. By arranging the concave section in the extra-high pressure mercury lamp side, the visible light which has transmitted through the front glass turns into pseudo parallel light. Furthermore, by providing the reflective film in the plane section side, the ultraviolet radiation and infrared light which are emitted from the electric discharge arc are returned to part of the electrodes and the electric discharge arc, through the almost same optical path as an optical path in which the lights are emitted from the discharge arc and then enter into the reflective film provided in the front glass. Therefore, as described above, while it is possible to change the temperature of the electrode tip section into a predetermined high temperature at time of lighting even if the electric power for lighting is low, an optical output required for a projector apparatus can be secured.

In addition, when, as shown in FIG. 5A, the concave section having the reflective film is arranged in the extra high pressure mercury lamp side, and the plane section is arranged in the outside of the concave reflection mirror, or when, as shown in FIG. 5B, the plane section is arranged in the extra high pressure mercury lamp side, and the concave section having the reflective film is arranged in the outside of the concave reflection mirror, or when, as shown in FIG. 5C, the plane section on which the reflective film is formed is arranged in the extra high pressure mercury lamp side, and the concave section is arranged in the outside of the concave reflection mirror, the infrared light reflected on the front glass is not irradiated on the electrodes, and the ultraviolet radiation reflected on the front glass does not return to the electric discharge arc, so that the above described advantages cannot be expected.

The above-mentioned concave reflection mirror may have the spheroidal shape in which part of an ellipse is included in a cross sectional view thereof, taken along a plane including an optical axis thereof. The above-mentioned front glass may have a curved portion which curves toward the high pressure mercury lamp side so that there are technical advantages as set forth below. That is, the ultraviolet radiation and infrared light emitted from the electric discharge arc are reflected by the reflective film provided on the front glass, and returned to part of electrodes and an electric discharge arc so that the above-mentioned effects can be expected.

Thus, by reducing the electric power for lighting an extra-high pressure mercury lamp a projector apparatus can be made small in size and inexpensive, and there is also no adverse influence on the circumference components etc. of the light source apparatus. In such a case, mercury of 0.15 mg/mm³ or more may be enclosed in the arc tube.

### BRIEF DESCRIPTION OF DRAWINGS

Other features and advantages of the present light source apparatus will be apparent from the ensuing description, taken in conjunction with the accompanying drawings, in which:

FIG. 1A is a cross sectional view of a light source apparatus, taken along a plan including the optical axis thereof;

FIG. 1B is an enlarged view of a portion A of FIG. 1A;

FIGS. 2A and 2B are conceptual diagrams for explaining the technical meaning of embodiments;

FIG. 3A is a sectional view of another embodiment of a light source apparatus, taken along a plan including the optical axis thereof;

FIG. 3B is an enlarged view of a portion B of FIG. 3B;

FIG. 4A is a cross sectional view of still another embodiment of the light source apparatus, taken along a plan including the optical axis;

FIG. 4B is an enlarged view of a portion C of FIG. 4A.

FIGS. 5A, 5B, and 5C are cross sectional views, taken along a plan including the optical axis of a conventional light source apparatus; and

FIG. 6 is a conceptual diagram for explaining the technical meaning of embodiment.

### DETAILED DESCRIPTION

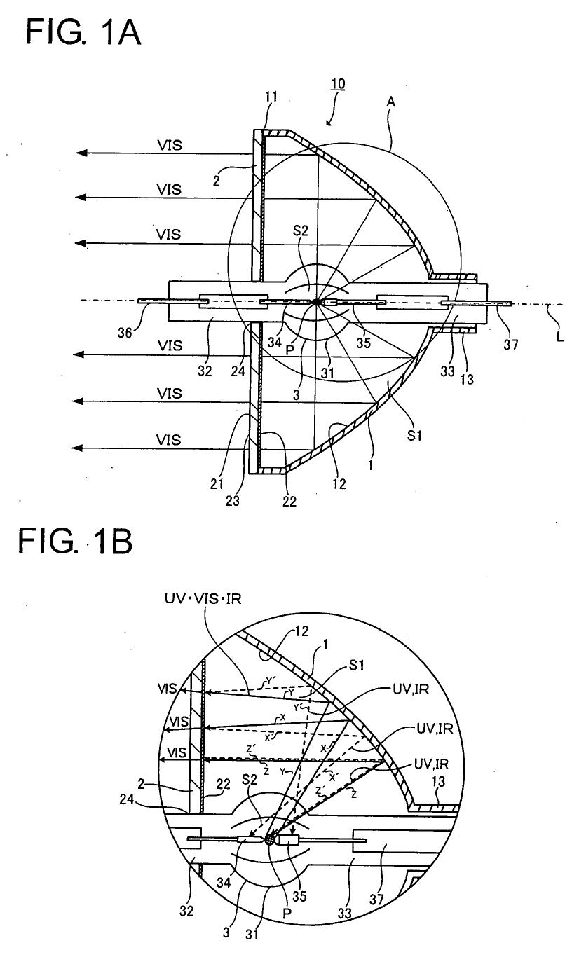

FIG. 1A is a cross sectional view of a light source apparatus, taken along a plan including an optical axis of a light source apparatus according to an embodiment. FIG. 1B is an enlarged view of a circled portion A of FIG. 1A.

In FIGS. 1A and 1B, “UV” represents ultraviolet radiation, “VIS” represents visible light, and “IR” represents infrared light. The “ultraviolet radiation” means short wavelength light having a band of the wavelength shorter than 380 nm, which is outside violet light wavelength. The “visible light” means light having a visible wavelength, which is in a 380 to 780 nm wavelength band. The “infrared light” means long wavelength light having a wavelength longer than 780 nm, which is in an infrared light wavelength band. A light source apparatus 10 comprises a bowl-like concave reflection mirror 1 which reflects light emitted from an extra-high pressure mercury lamp 3, a front glass 2 arranged at an opening end portion 11 of the concave reflection mirror 1, in which the extra high pressure mercury lamp 3 is arranged so that a portion where an electric discharge arc is formed may be in agreement with the first focal point of the concave reflection mirror.

In such a light source apparatus, voltage is impressed between electrodes 34 and 35 of the extra-high pressure mercury lamp 3 from a lighting ballast (not shown) for the extra-high pressure mercury lamp, so that dielectric breakdown may be carried out between the electrodes 34 and 35 to form discharge arc, and UV, VIS, and IR may be emitted from a discharge arc P. As indicated by an arrow Z, the UV, VIS, and IR which are emitted from the electric discharge arc P, are reflected in a direction parallel to an optical axis L, on the concave reflection mirror 1, and only VIS transmits through the front glass 2 and enters into the optical system of the projector apparatus. On the other hand, by the reflective film 22 provided on the front glass 2, the UV and IR are returned to the electric discharge arc P through the same optical path as the solid line arrow Z, as shown by a broken line arrow Z′.

In addition, although the UV, VIS and IR which are emitted from an area adjacent to the center portion of the electric discharge arc P, follow the almost same optical path as the path z as shown in the enlarged view of the portion A of FIG. 1B, since an electric discharge arc has a limited size, when the UV, VIS, and IR emitted from the tip of the electrodes 34 and 35 which is located away from the focal point of the concave reflection mirror, are reflected on the concave reflection mirror, they are not completely in parallel to the optical axis of the concave reflection mirror. For example, as shown by an arrow X, after the UV, and IR emitted from the tip of one electrode 35 are reflected by the concave reflection mirror 1 and enters into the reflective film 22 provided on the front grass 2, they are reflected on the reflective film 22 and then reflected on the concave reflection mirror 1 again so as to be irradiated onto the other electrode 34, as shown in an arrow X′. As shown by an arrow Y, after the UV, and IR emitted from the tip of the other electrode 34 are reflected by the concave reflection mirror 1 and then reflected by the reflective film 22 provided on the front grass 2, they are reflected on the reflective film 22 and then reflected on the concave reflection mirror 1 again so as to be irradiated onto the one electrode 35, as shown in an arrow Y′. Thus, the light emitted from the electric discharge arc P is irradiated onto the electric discharge arc P and part of the electrodes 34 and 35.

The concave reflection mirror 1 is made from metal material such as aluminum, and a cross section of the reflective surface 12 includes part of a parabola, as shown in FIG. 1. And further, a cylindrical neck portion 13 is formed so as to be connected to a reflective surface 12 without any gap, so that the concave reflection mirror may form a bowl shape as a whole. One of sealing portions 33 of the extra-high pressure mercury lamp 3 is inserted in and integrally fixed to the cylindrical neck portion 13, by adhesives. In addition, the concave reflection mirror 1 may be formed by glass or resin, and the vapor-deposited film made of metal, such as aluminum, may be formed on the reflective surface 12. Since at least the reflective surface 12 of the concave reflection mirror 1 is made from metal material, all the UV, VIS, and IR emitted from the extra-high pressure mercury lamp 3 can be reflected thereby. Therefore, the UV and IR do not transmit through the concave reflection mirror 1 as in the conventional light source apparatus, and there is no problem that the circumference components of the light source apparatus is exposed to the UV and IR thereby causing deterioration. Moreover, since it is possible to produce the concave reflection mirror 1 easily in a desired form by press processing, etc., using metal mold etc. where it is made from metal, compared with the case where it is made of glass etc., it is advantageous in terms of processability and mass-production nature. When a light reflex property, processability, cooling ease, weight, cost, etc. are taken into consideration, it is desirable to use aluminum as a metal material which forms the concave reflection mirror 1.

Moreover, in case where electric power for lighting can be lowered and reflection mirror temperature can be controlled so as to be low, there is a method in which the reflection mirror may be formed and manufactured by using resin, and metal material, such as aluminum may be deposited onto the reflective surface. In the case of resin forming, even if it has a complicated shape, it is possible to form a more inexpensive and sufficiently accurate concave reflection mirror, compared with the case of metal forming. In addition, it is not necessary to provide the reflective film made from a dielectric multilayer film on the reflective surface 12 of the concave reflection mirror 1 made of aluminum. That is, a reflective film may or may not be provided.

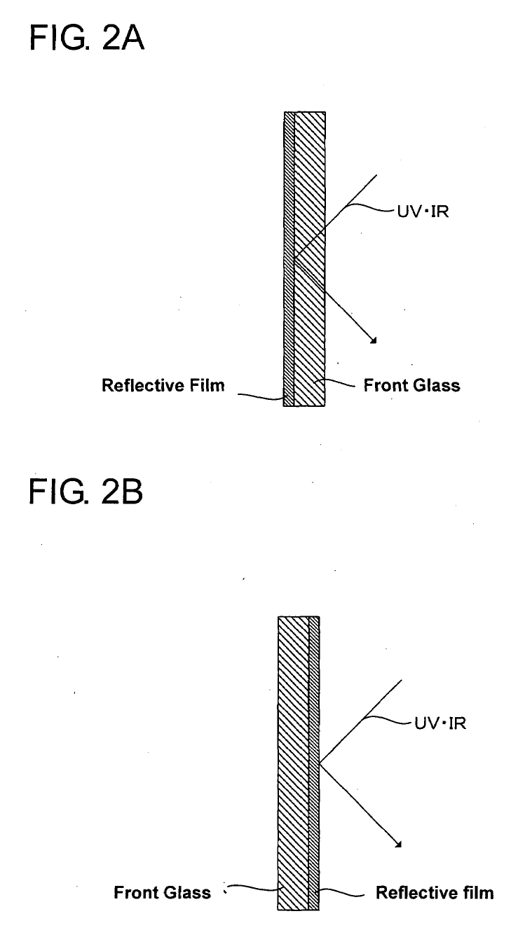

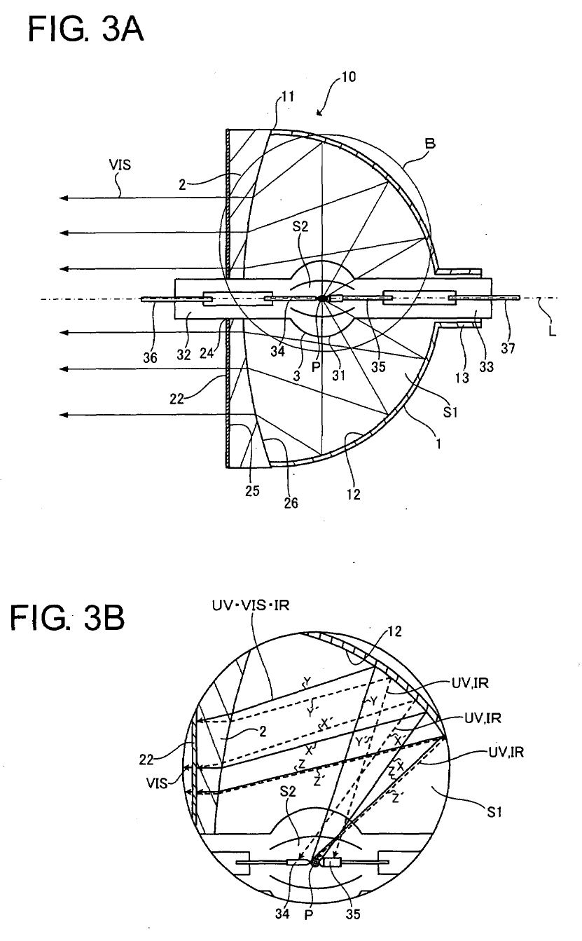

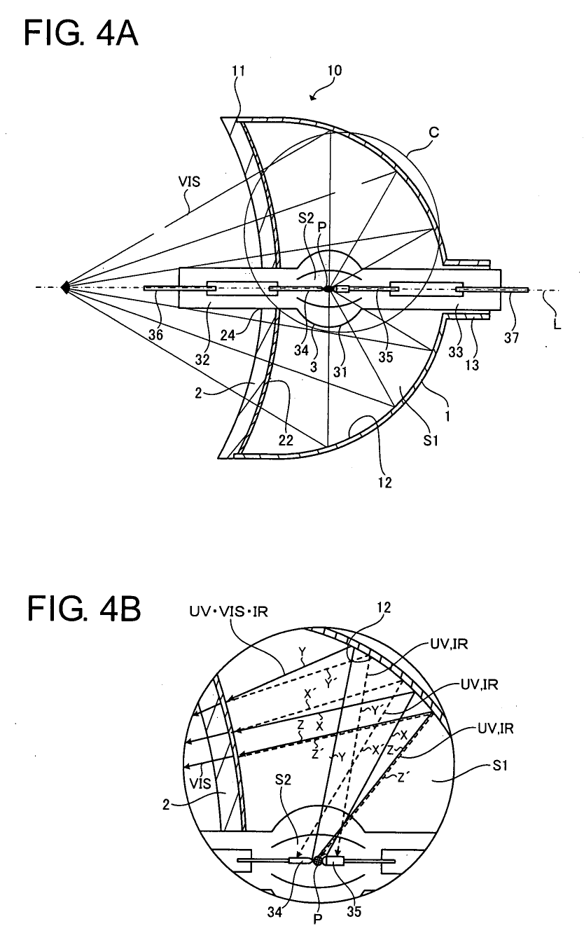

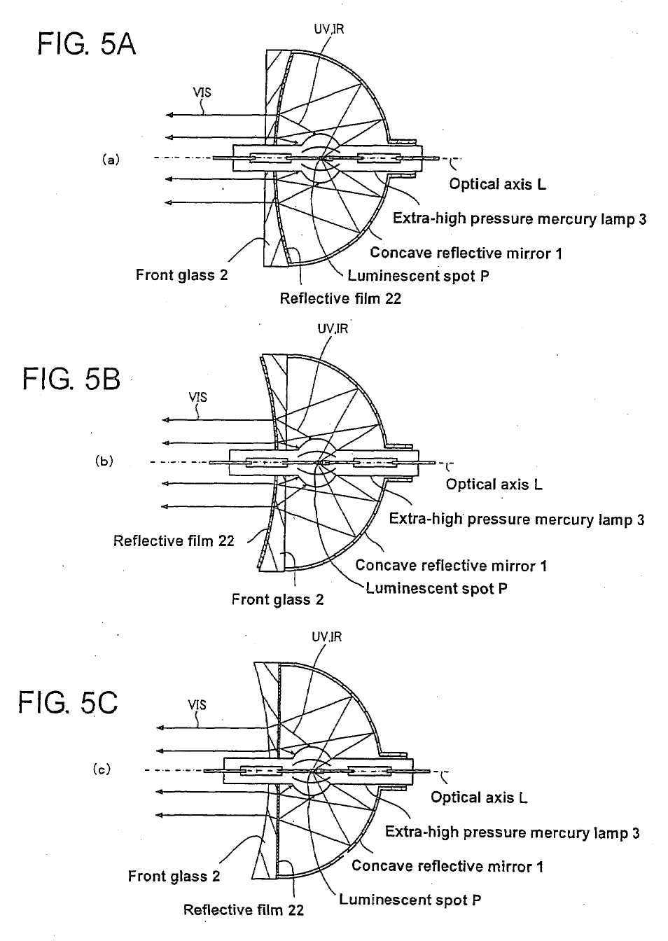

The front glass 2 may be made from material for example, glass etc., which transmits through at least visible light and inserted in and fixed to an opening end portion 11 of the reflection mirror 1. The front glass 2 is provided for preventing lamp fragments from dispersing towards the components in the projector apparatus, even just in case the extra-high pressure mercury lamp 3 installed in the concave reflection mirror 1 explode during lighting. A sealing portion 32 located in the light emitting side of the extra-high pressure mercury lamp 3 is projected toward the outside of the concave reflection mirror 1 from a through hole 24 provided in the central part of the front glass 2. The reflective film 22 made from a dielectric multilayer film is formed on a surface 21 of the front glass 2, which is located in the extra-high pressure mercury lamp side of the front glass. The reflective film 22 made from a dielectric multilayer film is designed so as to reflect the UV and IR among the UV, VIS, and IR which are directly emitted from the extra-high pressure mercury lamp 3 or reflected by the concave reflection mirror 1, toward the extra-high pressure mercury lamp 3, in which the VIS transmits through the reflective film 22. As described above, referring to FIG. 2B, it is desirable that the reflective film 22 be provided on the surface 21 which is located on the extra-high pressure mercury lamp side of the front glass 2. However, if the above mentioned light loss is disregarded, the reflective film 22 can also be provided on the outer side surface 23 of the front glass 2, as shown in FIG. 2A. In an example shown in FIGS. 1A and 1B, although the front glass 2 is attached to the concave reflection mirror 1, the position where the front glass is attached is not limited thereto, that is, it may be fixed to, for example, a member inside the projector apparatus. Examples shown in FIGS. 3A, 3B, 4A and 4B, the position of the front glass is not limited to the examples.

In addition, when the front glass 2 is fitted in the opening end portion of the concave reflection mirror 1, so that as shown in FIG. 1B, an enclosed space S1 is formed inside the concave reflection mirror 1, since the interior of the concave reflection mirror 1 may be in a high temperature state, there is an advantage that the non-evaporated mercury mentioned above is hardly generated even if the electric power for lighting the extra-high pressure mercury lamp is lowered.

The extra-high pressure mercury lamp 3 has an approximately spherical light emitting section 31 and the sealing portions 32 and 33 which are continuously formed from the both ends of the light emitting section 31. Part of conductive members 36 and 37 for electric supply connected to the lighting ballast are buried in the sealing portions 32 and 33, respectively, and part of the conductive members 36 and 37 are projected toward the outside of the respective sealing portions. Mercury of 0.15 mg/mm³ or more, rare gas of 0.1 to 100 KPa such as argon gas etc. for assisting an initiation of lighting, and halogen gas of 2×10⁻⁴ to 7×10⁻³ μmol/mm³ for performing a halogen cycle are enclosed in the inner space S2 of the light emitting section 31 (FIGS. 1A and 1B). In the inner space S2 of the light emitting section 31, a pair of the electrodes 34 and 35 made of tungsten is arranged so as to face each other. A large amount of mercury, for example, 0.15 mg/mm³ or more is enclosed in the inner space S2 of the light emitting section 31 so that the mercury vapor pressure at the time of lighting may be raised in order to extract an arc and to improve brightness. This case is different from the case of other discharge lamps, such as a metal halide lamp.

In the light source apparatus, as shown in the enlarged view (FIG. 1B) of a circled portion A of FIG. 1A, the UV and IR which are emitted from near the center of the electric discharge arc P are reflected in a direction parallel to optical axis L by the concave reflection mirror 1, and are returned to near the electric discharge arc P through the same optical path as that shown in a broken line arrow Z, on the reflective film 22 provided on the front glass 2, as shown in a broken line arrow Z′. As shown by a solid line arrow X, after the UV and IR which are emitted from the tip of the one electrode 35, are reflected on the concave reflection mirror 1 so as to be incident to the reflective film 22 provided on the front glass 2, as shown by the broken line arrow X′, they are reflected by the reflective film 22 and reflected on the concave reflection mirror 1 again so as to be irradiated onto the other electrode 34. As shown by a solid line arrow Y, after UV and IR which are emitted from the tip of the other electrode 34, are reflected by the concave reflection mirror 1 and reflected by the reflective film 22 provided in the front glass 2, as shown in a broken line arrow Y′, they are reflected by the concave reflection mirror 1 again so as to be irradiated onto the one electrode 35. Therefore, it is possible to irradiate them to the electric discharge arcs P and part of the electrodes 34 and 35. Since the tip section of the electrode 34 can be raised to a predetermined high temperature even where, among the rays emitted to discharge arc and the electrodes, especially IR heats the electrode 34 positively, and electric power for lighting the extra-high pressure mercury lamp 3 can be lowered, the thermionic emission does not become insufficient, and a flicker phenomenon does not occur. Further, since especially the UV excites the mercury in the discharge arc-discharge space, the optical output at the electric discharge arc P is improved, and even if electric power for lighting the extra-high pressure mercury lamp is lowered, a predetermined optical output can be secured.

Next, an experimental result of the light source apparatus shown in FIGS. 1A and 1B is described below.

In the experiment, a direct-current lighting type extra-high pressure mercury lamp was used, in which the reflective surface 12 of the concave reflection mirror 1 was made of aluminum, and the lamp had a paraboloidal surface. The extra-high pressure mercury lamp 3 was arranged so that it may be in agreement with a portion where an electric discharge arc may be formed in the focal point of the concave reflection mirror 1. In the experiment, a conventional light source apparatuses in which only visible light transmits through the front glass 2, and the present light source apparatuses having a film on the front glass 2 in which infrared light and ultraviolet radiation were reflected and visible light transmits through it, were used. That is, in the examination, ten extra-high pressure mercury lamps were prepared, that is, 2 types of lamps (5 each), in which the structure and the size of the concave reflection mirror 1 and the extra-high pressure mercury lamps 3 were the same, except for the front glass 2. Lamp voltage and screen illuminance were measured while the lamp lighting electric power is changed. The lamp voltage was determined by the amount of mercury which evaporates within the electrical discharge space, in other words, by the operating pressure, and the distance between electrodes. Therefore, if non-evaporated mercury exists in the electrical discharge space, since the operating pressure will fall so that lamp voltage becomes low, a lamp current value will become large relatively, when the electric power is the same. Moreover, since the mercury contributed to screen luminescence is reduced substantially, the expected screen illuminance cannot be attained. Therefore, it is effective to measure the lamp voltage and the screen illuminance as a measuring means to assume the electric power which can be used.

In Table 1, a measurement result of the lamp voltage and screen illuminance in case where the conventional front glass was used, and in case where a film through which visible light transmits, was formed in the side of the extra-high pressure mercury lamp is shown.

TABLE 1

| | Front Glass | |
|---|---|---|
| | | (Embodiment) |
| | (Conventional Example) | Infrared light |
| Lamp Input Power | Visible light | ultraviolet radiation |
| (W) | transmission | and visible light |
| 40 | X | X |
| 50 | X | Δ |
| 60 | X | ◯ |
| 70 | X | ◯ |
| 80 | X | ◯ |
| 90 | X | ◯ |
| 100 | Δ | ◯ |
| 110 | ◯ | ◯ |
| 120 | ◯ | ◯ |
| 130 | ◯ | ◯ |

In the table, the symbol “◯” shows a case where voltage was dropped by 3 V or less from the voltage at time when the lamp was lighted at 130 W, and further the screen illuminance did not become lower than that calculated based on power ratio. The extra-high voltage lamps in which the conventional front glass was used for the experiment were ones in which mercury could be evaporated completely, and stably operated at 130 W. That is, the symbol “◯” shows both of a case where the voltage dropped by 3 V or less from the voltage at the time of 130 W due to complete evaporation of the mercury, and a case where the voltage dropped by 3 V or less from the voltage at the time of 130 W although the mercury was not completely evaporated. On the other hand, a symbol “Δ” shows a case where although the voltage dropped by approximately 3 to 5 V, the screen illuminance was not lower than that calculated based on the power ratio, and it was in a state of the operatable lower limit. Moreover, a symbol “>X” shows a state where the screen illuminance was lower than the value calculated based on the power ratio so that it could not be stably used.

As shown in the table 1, it was possible to make the lamp which could not have been used at up to 100 W, usable at up to 50 W by reflecting infrared light and ultraviolet radiation by the front glass according to the embodiment, and by forming a vapor-deposited film through which visible light transmits. Moreover, it was confirmed that an optical output became high, compared with a case where the conventional front glass was used at time of lighting at 130 W, and the luminous efficiency (lm/W) became high. This is because the mercury which existed in a low-temperature range in the electrical discharge space could be excited so as to make it contribute to luminescence.

FIG. 3A is a cross sectional view of a light source apparatus according to another embodiment, taken along a plan including an optical axis. FIG. 3B is an enlarged view a portion B of FIG. 3B.

In FIGS. 3A and 3B, the same numerals are assigned to the same elements as those of FIG. 1. The concave reflection mirror 1 has a spheroidal shape whose cross section taken along a plan including the optical axis L includes part of an ellipse. The front glass 2 has a plane section 25 on which the reflective film 22 is formed, and a concave section 26, in which the front glass has a concave surface shape as a whole, the concave portion 26 is formed in the extra-high pressure mercury lam side, and the plan section 25 is formed in the outside of the concave reflection mirror 1. The reflective film 22 which is made from, for example, a dielectric multilayer film is formed on the plane section 25. A through hole 24 is provided in a central part of the front glass 2. The sealing portion 32 located in the light emitting side of the extra-high pressure mercury lamp 3 is projected from the through hole 24 of the front glass 2 toward the outside of the concave reflection mirror 1. According to the embodiment shown in FIG. 3B, as especially shown in an enlarged view of the circled portion B of FIG. 3A, UV, VIS, and IR which are emitted from a portion adjacent to the center of an electric discharge arc P of the extra-high pressure mercury lamp 3 are reflected in a light emitting direction by the concave reflection mirror 1, and only VIS transmits through the front glass 2 and enters to the optical components provided in the projector apparatus as parallel light. As shown by a solid line arrow Z, after the UV and IR which are emitted from a portion adjacent to the center of the electric discharge arc P are reflected by the concave reflection mirror 1 and enter into the front glass 2, they are reflected by the reflective film 22 provided on the plane section 25, and returned to the electric discharge arc P through the same optical path as the solid line arrow Z, as shown in a broken line arrow Z′. As shown by an arrow X, after the UV, and IR emitted from the tip of one of electrodes 35 are reflected by the concave reflection mirror 1 so as to enter into the front grass 2, they are reflected by the reflective film 22 provided on the plan section 25, and reflected by the reflection mirror 1 again, so as to be irradiated onto the other electrode 34, as shown in a broken line arrow X′. As shown by an arrow Y, after the UV, and IR emitted from the tip of the other electrode 34 are reflected by the concave reflection mirror 1 so as to enter into the front glass 2, they are reflected by the reflective film 22 provided on the plan section 25, and reflected by the concave reflection mirror 1 again so as to be irradiated onto the one electrode 35, as shown in a broken line arrow Y′. Therefore, in the above structure, it is possible to secure a predetermined optical output, as described above, and a flicker phenomenon does not occur, even if electric power for lighting is lowered. In addition, in the embodiment shown in FIGS. 3A and 3B, since the concave reflection mirror 1 having the spheroidal shape and the front glass 2 having the concave section 26 are combined so as to be used, it is possible to make the condensing area of VIS which becomes parallel light smaller than that of the embodiment shown in FIG. 1. Therefore, the optical system such as an integrator lens etc. arranged in a liquid crystal projector apparatus can be miniaturized, so that the liquid crystal projector apparatus itself can be miniaturized.

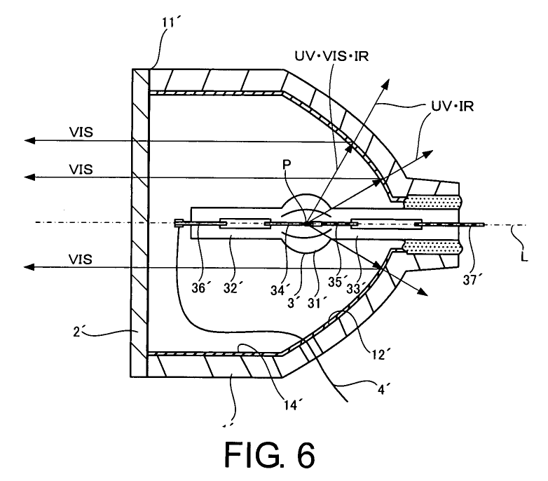

In addition, according to the embodiment shown in FIGS. 3A and 3B, in the front glass 2, the reflective film 22 is provided in the plane section 25 provided in the outside of the concave reflection mirror 1, so that, since the UV and IR emitted from the extra-high pressure mercury lamp 3 transmit through the front glass 2 twice, as mentioned above, in case where the front glass 2 is made from quartz glass, light loss of UV and IR will be about 16%. However, when the concave reflection mirror 1 having a spheroidal shape is used, as described above referring to FIG. 6, since the structure other than the structure shown in FIGS. 3A and 3B may not be adopted therefor, the light loss is ignored in this application.

FIG. 4A is a cross sectional view of a light source apparatus according to still another embodiment, taken along a plan including the optical axis thereof. FIG. 4B is an enlarged view of a portion C of FIG. 4A. The same numerals as those shown in FIGS. 1A, 1B, 3A and 3B are assigned to elements which are the same as or correspond to those of FIGS. 1A, 1B, 3A and 3B. The concave reflection mirror 1 has a spheroidal shape, in which a cross sectional view taken along a plan including the optical axis L includes part of an ellipse. The front glass 2 which curves toward the side of the extra-high pressure mercury lamp 3, and a through hole 24 is provided in a central portion thereof. The sealing portion 32 located in the light emitting side of the extra-high pressure mercury lamp 3 is projected from the through hole 24 of the front glass 2 toward the outside of the concave reflection mirror 1. According to the embodiment shown in FIGS. 4A and 4B, as especially shown in the enlarged view of the portion C of FIG. 4B, the UV, VIS, and IR which are emitted from the electric discharge arc P of the extra-high pressure mercury lamp 3 are reflected on the concave reflection mirror 1 in a light emitting direction, and only the VIS transmits through the front glass 2 so as to be condensed at the second focal point of the concave reflection mirror 2 so as to enter into an optical components provided in the projector apparatus, which is arranged at the second focal point of the concave reflection mirror 2. The UV, and VIS which are emitted from near the center of the electric discharge arc P are reflected by the concave reflection mirror 1 as shown in a solid line Z, so as to be reflected by the reflective film 22 provided on the front glass 2, and as shown in a broken line Z′, they are reflected by the concave reflection mirror 1 again, and returned to the discharge arc P though the same optical path as the solid line arrow Z. The UV and IR which are emitted from the tip of one electrode 35 are reflected by the concave reflection mirror 1 as shown in a solid arrow X, and reflected by the reflective film 22 provided on the front glass 2, so that, as shown by a broken line X′, they are reflected by the concave reflection mirror 1 again so as to be irradiated onto the other electrode 34. The UV and IR which are emitted from the tip of the other electrode 34 are reflected by the concave reflection mirror 1 as shown in a solid arrow Y, and reflected by the reflective film 22 provided on the front glass 2, so that, as shown by a broken line Y′, they are reflected by the concave reflection mirror 1 again so as to be irradiated onto the one electrode 35. Therefore, while a predetermined optical output can be secured as described above even if electric power for lighting is made low, a flicker phenomenon does not arise.

In addition, in the embodiments shown in FIGS. 1A, 1B, 3A, 3B, 4A and 4B, the one sealing portion 32 of the extra-high pressure mercury lamp 3 is projected toward the outside of the concave reflection mirror 1 from the through hole 24. In the structures, it is advantage that part of the conductive member 36 which projects from the sealing portion 32 would not disconnected at time of lighting of the extra-high pressure mercury lamp 3 (breaking of wire). Therefore, since it is not necessary to provide a cooling means for cooling the conductive member 36, it is advantageous in terms of cost.

In addition, the lighting method of a discharge lamp used for the present light source apparatus is not limited to those described above, and either DC lighting type, or AC lighting type method may be adopted, so that similar effects can be obtained.

The preceding description has been presented only to illustrate and describe exemplary embodiments of the light source apparatus according to the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A light source apparatus comprising:
an extra-high pressure mercury lamp having an arc tube having a light emitting portion and sealing portions extending from both sides of the light emitting portion, respectively, in which a pair of electrodes facing each other is provided and, mercury of 0.15 mg/mm³ or more is enclosed,
a concave reflection mirror which reflects light emitting from the discharge lamp in a predetermined direction and which surrounds the extra-high pressure mercury lamp, and
a front glass made from light transmissive material, which is arranged in an opening side of the concave reflection mirror,
wherein a reflective surface of the concave reflection mirror is made of metal, and,
wherein a reflective film which reflects infrared light and ultraviolet light, is formed on a surface of the front glass, and the infrared light and ultraviolet light which emitted from the extra-high mercury discharge lamp are reflected on the front glass so as to be returned to part of electrodes of the extra-high pressure mercury lamp or between the electrodes.

2. The light source apparatus according to claim 1, wherein the reflective film is formed on a surface of the front glass in extra-high pressure mercury lamp side thereof.

3. The light source apparatus according to claim 1, wherein the concave reflection mirror has a spheroidal shape in which part of an ellipse is included in a sectional view thereof taken along a plane including an optical axis, and the front glass has a concave section and a plane section in which the reflective film is provided so as to have a concave shape as a whole, and the concave section is located in the extra-high-pressure-mercury-lamp side thereof and the plane section is located outside of the concave reflection mirror.

4. The light source apparatus according to claim 1, wherein the concave reflection mirror has a spheroidal shape in which part of an ellipse is included in a sectional view thereof taken along a plane including an optical axis, and the front glass has a curved portion which curves toward the high pressure mercury lamp side.

5. The light source apparatus according to claim 2, wherein the concave reflection mirror has a spheroidal shape in which part of an ellipse is included in a sectional view thereof taken along a plane including an optical axis, and the front glass has a curved portion which curves toward the high pressure mercury lamp side.
